(19) United States
(12) Patent Application Publication
(10) Pub. No.: US 2015/0285474 A1
(43) Pub. Date: Oct. 8, 2015

(54) PRINTED CIRCUIT BOARD FOR POPULATING WITH ILLUMINATION BODIES, COMPRISING A VARIABLE WORKING WINDOW

(71) Applicant: ZUMTOBEL LIGHTING GMBH, Dornbirn (AT)

(72) Inventors: Kenneth Martin, Lauterach (AT); David Gajdos, Dornbirn (AT); Steffen Block, Lauterach (AT); Christian Daniel, Lindau (DE)

(21) Appl. No.: 14/435,163

(22) PCT Filed: Oct. 9, 2013
(86) PCT No.: PCT/EP2013/071038

§ 371 Date: Apr. 11, 2015

(30) Foreign Application Priority Data
Oct. 12, 2012 (DE) 20 2012 103 898.6

(51) Int. Cl. F21V 21/00; F21V 23/06

(52) U.S. Cl. CPC F21V 21/00; F21V 23/06; F21Y 2105/001

(57) ABSTRACT

A printed circuit board for populating with illumination bodies, in particular LEDs, the board having population regions with connection options for the illumination bodies. A number of the population regions are connected in series by conductor tracks to form a group. The printed circuit board is further provided with additional connection options for electrical connection elements, in particular for 0-ohm resistors, via which at least some of the groups can be connected either in parallel or in series.

The present invention relates to a printed circuit board for populating with light-emitting elements in accordance with the preamble of claim 1. The light-emitting elements are in particular LEDs, wherein the printed circuit board has so-called populating regions having connection possibilities for the light-emitting elements, and wherein in each case a plurality of these populating regions are connected in series to form a group via conductor tracks.

In electrical or electronic appliances in which a plurality of LEDs are used, printed circuit boards or circuit boards are often used on which the LEDs are arranged together. In this case, there is the problem that usually a new printed circuit board needs to be developed and produced for each new such appliance or each new application since the same color rendering, color intensity or the like or the same pattern and the same spacing is rarely required for different appliances or applications and there is a large number of different types of LEDs which differ, for example, in terms of their physical shapes and connection possibilities.

Owing to the respectively required redevelopment of a printed circuit board on which a plurality of LEDs can be fitted, there is a number of disadvantages. Firstly, there is the problem that the precise positioning of the LEDs is only known during the development of a new appliance or a new application, as a result of which only then is it possible to begin with the development of the corresponding printed circuit board, as a result of which correspondingly longer delivery times can result. Secondly, the sometimes low production numbers and the respectively newly required development of a layout for the printed circuit board can also result in increased costs.

In order to enable flexible population with LEDs, correspondingly printed circuit boards are already known which have a plurality of channels which are actuable separately from one another, wherein a plurality of connection possibilities, so-called footprints, for LEDs is provided on a channel. In this case, the printed circuit board then has a plurality of populating regions, wherein a connection possibility of each channel is arranged in each populating region.

A further problem in the case of the solutions known from the prior art furthermore consists in that the printed circuit boards with the LEDs located thereon are generally designed for operation with a specially adapted power supply source. This means that generally the printed circuit board needs to be operated using a converter, which provides a current which is specifically suitable for the operation of the LED module. The use possibilities for the end user are thus very restricted.

The present invention is therefore based on the object of specifying a novel solution which enables greater flexibility in the operation of LED modules. In particular, the intention is for the possibility to be provided of operating the module using different currents, wherein the current made available to the individual LEDs is intended to be in principle within a suitable range, however.

The object is achieved by a printed circuit board for populating with light-emitting elements as claimed in claim 1. Advantageous developments of the invention are the subject matter of the dependent claims.

As is also the case in the solutions already known from the prior art, provision is first made for a plurality of the connection possibilities for the light-emitting elements to be connected in series with one another to form a group. In accordance with the invention, however, the printed circuit board now has additional connection possibilities for electrical connecting elements, via which the groups or some of said groups can be connected either in parallel or in series with one another. These further connection possibilities according to the invention are in this case designed in particular for the connection of so-called 0-ohm resistors.

In accordance with the invention, therefore, a printed circuit board for populating with light-emitting elements, in particular LEDs, is proposed, wherein the printed circuit board has populating regions with connection possibilities for the light-emitting elements, and wherein in each case a plurality of the populating regions are connected in series with one another to form a group by conductor tracks. In accordance with the invention, the printed circuit board has further connection possibilities for electrical connecting elements, in particular for 0-ohm resistors, via which at least some of the groups can be connected either in parallel or in series with one another.

Owing to the fact that there is now the possibility of connecting a plurality of the groups either in parallel or in series with one another, the above mentioned desired flexibility in the power supply to the printed circuit board is achieved. Thus, the printed circuit board can be operated using a lower current in the case of a series interconnection of groups, while, on the other hand, a higher current intensity is required when there is a parallel interconnection. Depending on the type of converter provided, therefore, a corresponding interconnection of the groups can be performed in order to ensure optimum operation of the LEDs.

Further measures which are the subject matter of the dependent claims relate in particular to the arrangement of the populating regions on the circuit board and result in an additional improvement as regards the flexibility of the use of the printed circuit board and the behavior of the LED module in the event of a defect in individual LEDs.

In this case, provision is preferably made for the populating regions to be arranged so as to be uniformly distributed or in the form of a matrix on the printed circuit board. In particular, provision can be made in this case for the populating regions in one group to be arranged offset with respect to one another in two rows or columns located next to one another. The populating regions of two groups can then in each case be arranged interleaved with respect to one another in comb-like fashion, which brings with it the advantageous effect that, in the case of an LED defect which results in complete failure of the associated group, the entire row or column of the circuit board does not appear to be dark. Furthermore, in the case of such a configuration, there is also the possibility of populating only in each case every second group with LEDs, wherein, nevertheless, a uniform areal light emission over the entire printed circuit board is achieved. The flexibility for use of the printed circuit board is once again increased hereby. In this case, provision is preferably made for two groups interleaved with one another to be assigned to in each case two different or separate main groups which are connected in parallel, in the case of a series connection of the groups.

In accordance with another advantageous development, the flexibility for use of the printed circuit board is additionally increased by virtue of the fact that the said printed circuit board has connections for power supply lines or for connection to further printed circuit boards, wherein the connections are designed for connection to at least two different contact types. This also substantially contributes to the increase in flexibility since different types of contacts are available on the market and therefore the end user can use the contacts available flexibly. This concept can moreover also be used independently of the previously described properties of the printed circuit board.

Provision is preferably made for a plurality of the printed circuit boards according to the invention to be connected to one another in order to form an areal arrangement for light emission. In this case, provision can in particular be made for printed circuit boards of different sizes to be available. Nevertheless, in this case, provision is then preferably made for the distance between the populating regions on the printed circuit boards to be independent of the respective size of the printed circuit board. That is to say that the various printed circuit boards differ, apart from in terms of their size, in particular also in respect of the number of LEDs arranged thereon. If printed circuit boards are interconnected with one another in series and are correspondingly operated using the same current, this has the consequence that a slightly higher current is present in the case of smaller printed circuit boards at the associated LEDs and said LEDs illuminate more brightly correspondingly. This effect can advantageously be used, however, to form certain free spaces within the areal arrangement for light emission, which free spaces can be used for arranging non-light-emitting elements, for example converters or the like, wherein nevertheless a substantially homogeneous or uniform light emission is achieved over the entire area.

Ultimately, therefore, the printed circuit board according to the invention enables extremely versatile and flexible use by the end user.

The invention will be explained in more detail below with reference to the attached drawing, in which:

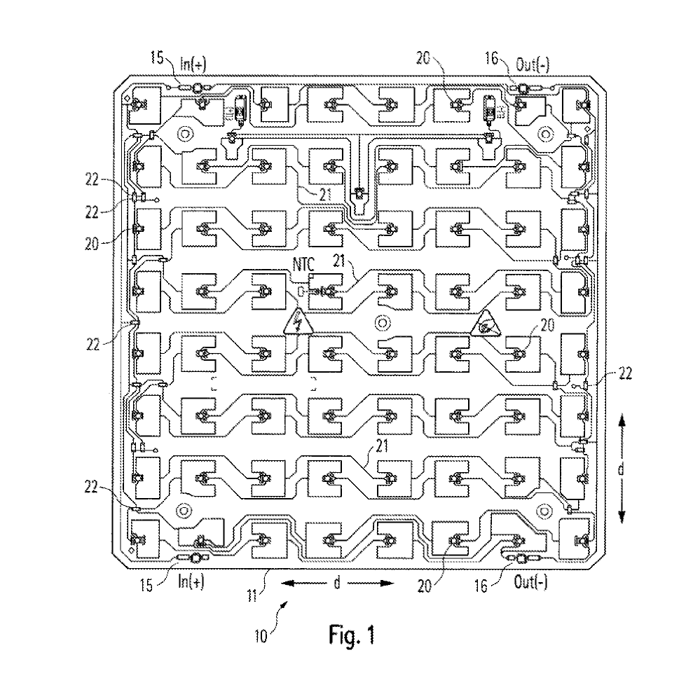

FIG. 1 shows a first exemplary embodiment of a printed circuit board according to the invention;

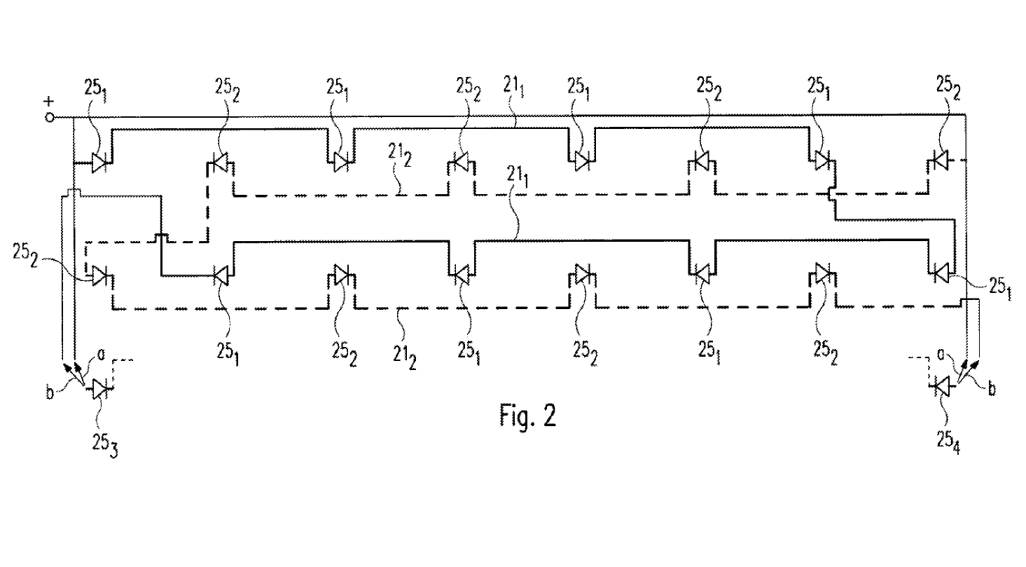

FIG. 2 shows an enlarged illustration of the connection of the LEDs or the populating regions to form groups;

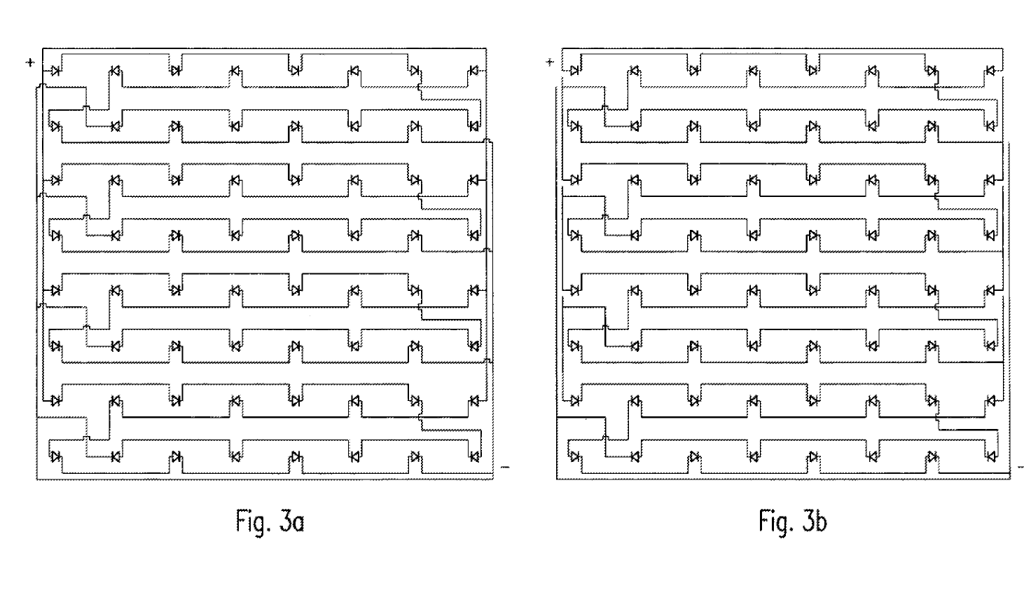

FIGS. 3a and 3b show illustrations for the alternative connection of the LED groups in the case of the printed circuit board shown in FIG. 1;

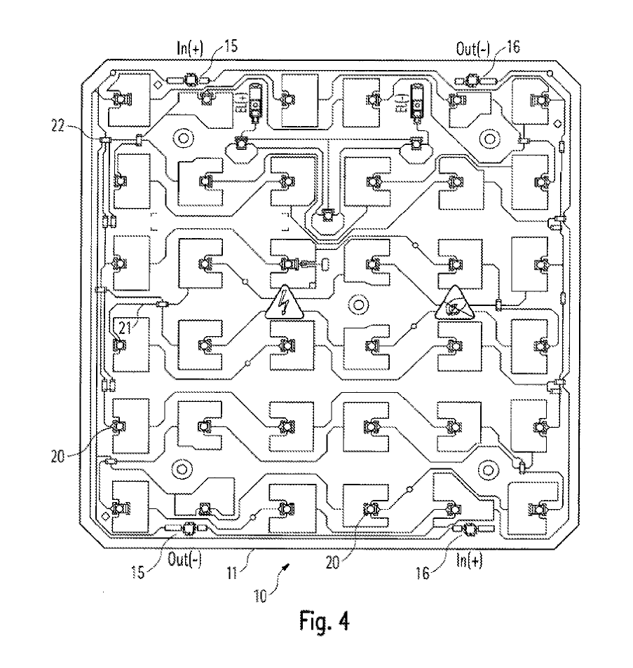

FIG. 4 shows a second exemplary embodiment of a printed circuit board according to the invention;

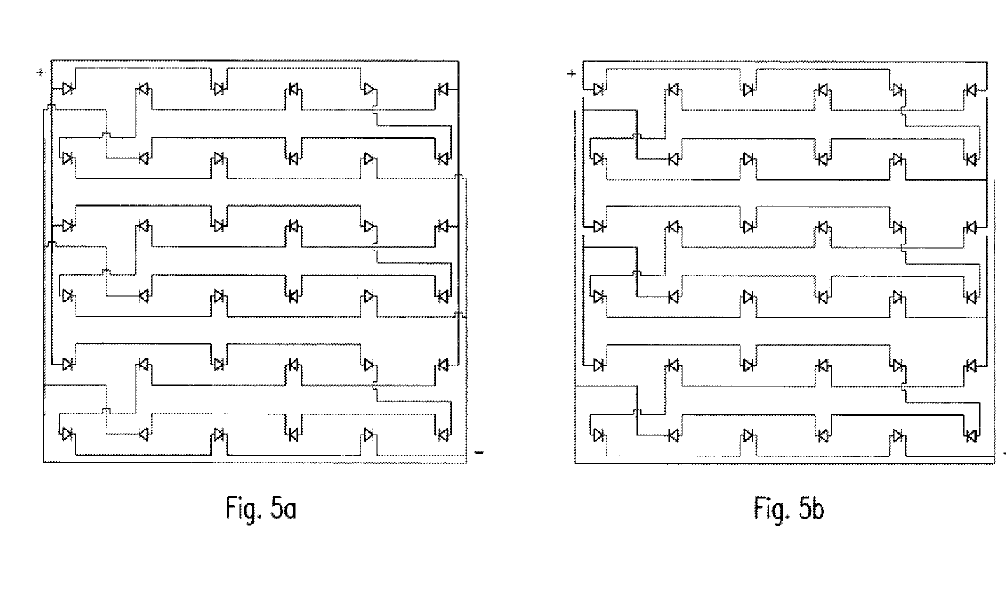

FIGS. 5a and 5b show illustrations for the alternative connection of the LED groups in the case of the printed circuit board shown in FIG. 4;

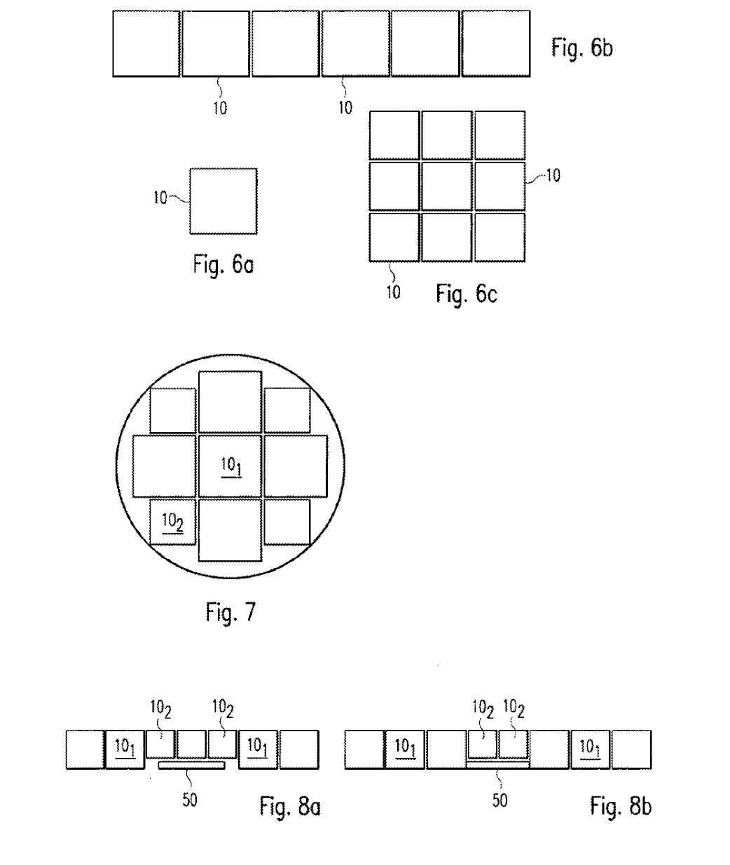

FIGS. 6a to 6c show possibilities for combining a plurality of printed circuit boards;

FIG. 7 shows a first possibility for combining printed circuit boards of different sizes, and

FIGS. 8a and 8b show further advantageous variants in the combination of printed circuit boards of different sizes.

FIG. 1 first shows a first variant of a printed circuit board 10 configured in accordance with the invention. The printed circuit board 10 illustrated is intended to be populated with in total 64 LEDs and, for this purpose, has a corresponding number of footprints or populating regions 20 arranged in an 8×8 matrix, which footprints or populating regions are arranged in a distributed manner on an areal, in particular an approximately square carrier element 11 in the form of a circuit board. The arrangement of the populating regions 20 is in this case such that the distance d between two adjacent populating regions 20 is the same size in principle both in the vertical direction and in the horizontal direction. The populating regions 20 are connected to one another via conductor tracks 21. In addition, positive and negative connections 15 and 16, respectively, are formed for the power supply to the printed circuit board 10 at the peripheral regions. These connections 15, 16 enable the connection of the printed circuit board 10 to a power supply unit (not illustrated), in particular a converter, which is designed to supply a constant current to the printed circuit board 10. In addition, with the aid of these connections 15 and 16, a plurality of printed circuit boards 10 can also be connected to one another in order to form an areal arrangement for light emission, as will be explained in more detail later.

In accordance with a particularly preferred embodiment of the invention, in this case provision is made for these connections 15 and 16 to be configured such that they enable the connection of different contact types. In particular, at least the connection to two different contact types should be possible. During final fitting of the printed circuit board populated with the LEDs, it is then therefore possible to use the corresponding connection type, if present. For example, it would be conceivable to configure the connections 15 and 16 in such a way that either so-called AVX insulation displacement contacts or so-called Molex plug-type connectors can be connected, which are very customary in this field. However, the use of other contact types would of course also be conceivable.

The populating regions 20 enable, as already mentioned, the respective connection of an LED so that in total 64 LEDs can be arranged on the illustrated printed circuit board 10 in order to achieve a maximum brightness. In this case, it is advantageous if the LEDs are operated using a substantially constant, possibly pulse-width-modulated, current since in this case extremely efficient LED operation is possible. This in turn means that the converter required for the power supply to the printed circuit board 10 must also provide a correspondingly suitable current. In order to reduce the resultant limitations for the converter and to open up the possibility of being able to use different converter types for operating the printed circuit board 10, a particular connection of the various populating regions 20 to one another is provided in accordance with the invention, which will be explained in more detail below with reference to FIGS. 2, 3a and 3b. For improved clarity in respect of the explanation of the solution according to the invention, in this case the connection of the populating regions or the now schematically illustrated LEDs by the conductor tracks is illustrated in simplified form.

Provision is first made for the populating regions 20 or, as illustrated in FIGS. 2, 3a and 3b, the LEDs 25 arranged on the populating regions 20 to be connected in series with one another to form groups via conductor tracks 21₁ and 21₂. A group of LEDs 25 is in this case not arranged along an individual line or column of the LED matrix, however, but instead are connected to one another via the conductor tracks 21₁ and 21₂, respectively, in such a way that there is an arrangement in two adjacent rows or columns, wherein the LEDs 25₁ and 25₂ are arranged offset with respect to one another. FIG. 2 shows in particular two groups, wherein the first group 25₁ is connected to one another via the conductor tracks 21₁ illustrated as a continuous line, while the second group 25₂ is connected via the conductor tracks 21₂ illustrated by dashed lines. It can be seen that both LED groups 25₁ and 25₂ are arranged interleaved with one another in the form of a comb.

This arrangement has several advantages. Firstly, the failure of a single LED 25 which results in an interruption to the power supply to all of the LEDs 25 in the associated group, does not result in a row or column of the LED matrix appearing completely dark, which would have a negative effect directly on the light emission. Instead, the two rows or columns merely appear with a reduced brightness since the associated other LED group is still active. The resultant reduction in brightness in this region has a much less negative effect on the overall appearance of the LED module than a complete failure of an entire column or row.

It would furthermore be conceivable for the populating regions 21₁ and 21₂ of two different groups interleaved with one another to be populated with different LEDs. This can be desirable in particular when a special hue or a special color temperature is desired for the light emission, which can only be achieved by the use of different LEDs. Owing to the interleaved arrangement of the two groups, improved and more efficient mixing of the light of the different LED types is achieved, which in turn results in improved light emission.

Finally, it would also be conceivable to populate in each case only one of the two groups with LEDs and not to use the other group of populating locations 20 at all. The brightness of the entire light emission is thus reduced, and a uniform light emission over the entire area of the printed circuit board 10 is achieved nevertheless owing to the distributed arrangement of the LEDs.

A particular feature of the printed circuit board according to the invention further consists in the way in which the LED groups are connected to one another or can be connected to one another. FIG. 2 shows completely only the two uppermost LED rows of the printed circuit board, wherein, in the exemplary embodiment shown in FIG. 1, in each case three further identically configured arrangements of in each case two LED groups interleaved with one another then adjoin the lower side of the arrangement shown in FIG. 2.

In accordance with the invention, provision is now made for the following LED groups to be capable of being connected either in series or in parallel with the previous groups. FIG. 2 illustrates in each case the first LED 25₃ and 25₄ of the next group on the lower side, in which case there is therefore the possibility of these LEDs 25₃ or 25₄ either being connected to the first or input-side LED of the upper group (illustrated by the connections a), which results in a parallel connection of the LED groups, or being connected to the output or the last LED of the preceding group (illustrated by the connections b), which results in a series connection of the groups with respect to one another.

This optional connection of the LED groups or the associated populating regions 20 is achieved with the aid of connection possibilities 22, which are likewise arranged on the printed circuit board 10 and are designed for the connection of so-called 0-ohm resistors. Depending on the way in which a connection of the LED groups is desired, 22 0-ohm resistors are positioned at these connection possibilities in order to connect the conductor tracks 21 correspondingly to one another. In the case of a parallel connection, there then results in total the connection of the LED groups illustrated in FIG. 3a to one another. However, for the case where a series interconnection of the groups is desired, the 0-ohm resistors are set in such a way that the arrangement illustrated in FIG. 3b results.

It should be noted here that, in the case of the series connection corresponding to FIG. 3b, provision is made for in each case only the identically oriented LED groups to be connected in series with one another. That is to say that in each case four groups are connected in series with one another to form a so-called main group, wherein the two main groups engaging in one another in the form of a comb are then in turn connected in parallel. In turn, the advantage results here that, in the case of failure of one LED, which would ensure an interruption to the entire main group of LEDs, light emission by means of the other main group continues as before and correspondingly at least not the entire LED module appears dark.

The possibility of connecting the LED groups in series or parallel with one another now has the result that there is greater flexibility in the selection of the power supply unit for operating the LED module. In the case of the parallel connection of the LED groups as shown in FIG. 3a, correspondingly in total eight groups are supplied current at the same time, wherein this current is distributed uniformly among the groups (if identical LEDs are used). That is to say that the current with which each individual LED is operated is one eighth of the current provided by the supply device. At the same time, the supply device needs to provide eight times the individual required LED voltage owing to the fact that a group consists of in each case eight series-connected LEDs.

In the case of the series connection of the groups as shown in FIG. 3b, on the other hand, the current is merely divided between the two main groups. That is to say that the current flowing through a single LED now corresponds to half the current provided by the converter. On the other hand, the converter now needs to provide 32 times an individual LED voltage. That is to say that, given the configuration shown in FIG. 3a, a supply device with a low-voltage supply in the range of from 18 to 24 V can be used, whereas, in the case of the circuit variant shown in FIG. 3b, a lower current needs to be provided, but a much higher voltage, for example in the region of 96 V, is required.

For the case where the LEDs in the LED groups forming the two main groups are different, in addition optionally also disconnection and therefore independent actuation of the two LED group types could be selected by virtue of the use of additional connection possibilities for bridges or 0-ohm resistors. This would be expedient, for example, in particular when, by virtue of separate actuation of both LED types, the light emission of the module is intended to be changed in respect of its color or color temperature. In this case there is then a two-channel interconnection, which is advantageous in particular in the case of so-called “tunable white” applications. Owing to the interleaved arrangement of the LED groups, a homogeneous emission of the resultant mixed light can be achieved in a simple manner. However, for the case where all of the LEDs are intended to be operated identically, a single-channel interconnection of the groups is sufficient.

A second exemplary embodiment of an LED circuit board according to the invention is illustrated in FIGS. 4, 5a and 5b, wherein identical elements have been provided with the same reference symbols. In respect of its configuration, this second variant substantially corresponds to the exemplary embodiment in FIGS. 1 to 3, wherein now the in total 36 populating regions 20 are arranged in a 6×6 matrix, however. In turn, owing to the use of the connection possibilities 22 for the 0-ohm resistors, the groups which now in each case consist of 6 LEDs 25 can be connected in series or parallel with one another, in which case the arrangement resulting in FIGS. 5a (parallel interconnection) or 5b (series interconnection) results. In the case of the parallel interconnection, in this case the LED current then corresponds to one sixth of the current made available by the converter; the voltage of the converter should correspond to 6 times the LED operating voltage, i.e. approximately 18 V in the case of a 3 V LED voltage. In the case of the series interconnection, on the other hand, the LED current in turn corresponds to half the current made available by the converter; the supply voltage of the converter should correspond to 18 times the LED voltage, on the other hand.

In the case of this printed circuit board too additional connection possibilities for bridges or 0-ohm resistors can be provided, with the aid of which either a single-channel actuation or two-channel actuation can be realized for the LEDs.

Interesting consequences which can be used for realizing an arrangement for light emission in the case of a combination of the printed circuit boards to form a larger area result from the fact that, in the case of a parallel circuit of the LED groups in the case of the printed circuit board shown in FIGS. 4 and 5, the current flowing through the LEDs corresponds to one sixth of the supply current, i.e. in the case of an identical converter and the same total supply current, is higher than in the case of the printed circuit board with an 8×8 LED matrix.

Thus, there is firstly obviously readily the possibility of combining the LED modules 10 with one another and arranging them to form different area configurations. FIGS. 6a to 6c in this case show, merely by way of example, some conceivable variants, wherein the isolated use of a single module 10 would of course also be conceivable.

Furthermore, there is also the possibility, however, of combining LED printed circuit boards of different sizes with one another. A first exemplary embodiment of this is shown in FIG. 7, in which five 8×8 modules 10₁ are combined with four 6×6 modules 10₂ in order to form an approximately circular light emission region. The use of different sizes of printed circuit boards in this case enables improved and more flexible matching of the entire arrangement to the desired region to be illuminated. It is also advantageous here that the distance between the individual LEDs in the case of both printed circuit board types 10₁ and 10₂ is identical in size.

A further possibility for combining printed circuit boards of different sizes is illustrated in FIGS. 8a and 8b. In this case, it is necessary to consider that, as mentioned previously, the current flowing through the LEDs of the smaller printed circuit boards 10₂ is slightly higher in the case of the use of identical converters or in the case of the same supply current for the printed circuit boards 10₁ and 10₂ and in the case of identical LEDs, and correspondingly the light sources are approximately 33% brighter in this case. Owing to the increased brightness of the LEDs of the smaller printed circuit boards 10₂, free spaces can be provided in the environment of these printed circuit boards, which free spaces can be used for arranging non-light-emitting components of the arrangement. In the exemplary embodiments illustrated, in each case the arrangement of, for example, a converter 50 for supplying current to the printed circuit boards 10₁ and 10₂ is illustrated. The converter 50 itself does not of course emit any light, but this is compensated for owing to the smaller and therefore brighter printed circuit boards 10₂ arranged directly adjacent thereto, with the result that ultimately a homogeneous light emission is achieved over the entire area if a corresponding optical system which ensures uniformity of the light emission is used.

The above-described solution has the advantage that the power supply units can be arranged on the same plane as the printed circuit boards and correspondingly the realization of large-area light-emitting arrangements with an extremely small physical height is enabled.

Ultimately, therefore, the present invention provides the possibility of being able to use printed circuit boards extremely flexibly for forming an areal light emission, wherein large-area light-emitting arrangements with a very small height can be realized.

1. A printed circuit board for populating with light-emitting elements, in particular LEDs, wherein the printed circuit board has populating regions with connection possibilities for the light-emitting elements, and wherein in each case a plurality of the populating regions are connected in series with one another to form a group by conductor tracks, wherein the printed circuit board has further connection possibilities for electrical connecting elements, in particular for 0-ohm resistors, via which at least some of the groups can be connected either in parallel or in series with one another.

2. The printed circuit board as claimed in claim 1, wherein the populating regions for the light-emitting elements are arranged in the form of a matrix on the printed circuit board.

3. The printed circuit board as claimed in claim 2, wherein the populating regions in one group are arranged offset with respect to one another in two rows or columns located next to one another.

4. The printed circuit board as claimed in claim 3, wherein the populating regions of two groups are each arranged interleaved with respect to one another in comb-like fashion, wherein, in the case of the groups being connected in series, two groups interleaved with one another are each assigned to two separate main groups, which are connected in parallel.

5. The printed circuit board as claimed in claim 1, wherein the said printed circuit board has connections for power supply lines or for connection to further printed circuit boards, wherein the connections are designed for connection to at least two different contact types.

6. The printed circuit board for populating with light-emitting elements, in particular LEDs, wherein the printed circuit board has populating regions having connection possibilities for the light-emitting elements and connections for power supply lines or for connection to further printed circuit boards, wherein the connections are designed for connection to at least two different contact types.

7. The printed circuit board system for forming an areal arrangement for light emission, which printed circuit board system has a plurality of printed circuit boards as claimed in claim 1.

8. The printed circuit board system as claimed in claim 7, wherein the printed circuit boards have different sizes.

9. The printed circuit board system as claimed in claim 8, wherein the distance between the populating regions on the printed circuit boards is independent of the respective size of the printed circuit board.

10. The arrangement for light emission comprising a printed circuit board system as claimed in claim 7 and power supply means for the printed circuit boards.

11. The arrangement for light emission as claimed in claim 10, wherein the power supply means are arranged on the same plane as the printed circuit boards.

12. The arrangement for light emission as claimed in claim 11, wherein the printed circuit boards of different sizes are used, wherein the power supply means are arranged in the region of the smaller printed circuit boards.
